(19) United States
(12) Patent Application Publication
(10) Pub. No.: US 2025/0064136 A1
(43) Pub. Date: Feb. 27, 2025

(54) AEROSOL PROVISION SYSTEM

(71) Applicant: NICOVENTURES TRADING LIMITED, London (GB)

(72) Inventor: Joseph Peter SUTTON, London (GB)

(21) Appl. No.: 18/722,646

(22) PCT Filed: Dec. 5, 2022
(86) PCT No.: PCT/GB2022/053086

§ 371 Date: Jun. 21, 2024

(30) Foreign Application Priority Data
Dec. 21, 2021 (GB) 2118588.9

(51) Int. Cl. A24F 40/53; A24F 40/42; A24F 40/46; A24F 40/51; A24F 40/65; A24F 40/95; H01M 10/42; H01M 10/44; H01M 10/48

(52) U.S. Cl. CPC A24F 40/53; A24F 40/51; A24F 40/65; A24F 40/95; H01M 10/425; H01M 10/443; H01M 10/486; A24F 40/42; A24F 40/46; H01M 2010/4278

(57) ABSTRACT

An aerosol provision system 1 comprises a battery 16 for providing power to an aerosol generator 40 and a sensor for generating sensor data over a predetermined period of time. Control circuitry 18 is configured to process the sensor data and charge level data relating to the charge level in the battery 16 to determine whether a notification should be generated. In response to determining that the notification should be generated, the control circuitry 18 generates a notification signal for output from an output device 200, which may be a suggestion to recharge the battery 16 in a predetermined different way to improve the performance of the battery 16 in the longer term. The sensor may comprise a temperature sensor, and the notification may suggest to recharge the battery in a warmer or a cooler location. Alternatively, the suggestion may be not to recharge the battery for so long or not to interrupt charging until the battery is fully charged.

### FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolisable material (also called aerosol-generating material), such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise a vaporiser (also called an aerosol generator), e.g. a heating element, arranged to aerosolise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision system. A potential drawback of existing aerosol provision systems and associated aerosol provision devices is that it can often be challenging for a user of the aerosol provision system to necessarily know if they are charging the aerosol provision system in efficient ways, which preserve the battery of the aerosol provision system in the long term. Indeed, in so far as the user may inadvertently adopt habits for charging the battery of the aerosol provision system inefficiently, such as through placing the aerosol provision system on charge for too long, or due to charging the aerosol provision system in an unduly cool or hot location, these habits if left unchecked may impair the health of the battery (power source) from the aerosol provision system in the long term.

Various approaches are therefore described herein which seek to help address or mitigate some of these issues, through the provision of a notification in the event the aerosol provision system determines that the battery from the aerosol provision system is being charged in an inefficient manner.

### SUMMARY

According to a first aspect of certain embodiments there is provided an aerosol provision system for generating an aerosol, wherein the aerosol provision system comprises:
an aerosol generator for generating the aerosol;
a battery for providing electrical power to the aerosol generator;
at least one sensor for generating sensor data over a predetermined period of time; and
control circuitry, wherein the control circuitry is configured to:
   generate charge level data relating to a charge level in the battery over the predetermined period of time;
   receive the sensor data from the at least one sensor over the predetermined period of time;
   process the sensor data and the charge level data to determine whether a notification should be generated; and
   generate a notification signal in response to determining that the notification should be generated.

According to a second aspect of certain embodiments there is provided a communication system comprising the aerosol provision system according to the first aspect, and an electrical device which is operable to wirelessly communicate with the aerosol provision system, wherein the electrical device further comprises an output device which is configured to:
receive the notification signal from the control circuitry; and
output the notification in response to receiving the notification signal.

According to a third aspect of certain embodiments there is provided a charging system comprising any aerosol provision system according to the first aspect, or comprising any communication system according to the second aspect, wherein the charging system further comprises a charging case configured to support the aerosol provision system and to provide charge to the battery from the aerosol provision system during the predetermined period of time.

According to a fourth aspect of certain embodiments there is provided a charging system comprising any aerosol provision system according to the first aspect, or comprising any communication system according to the second aspect, wherein the charging system further comprises a docking station configured to support the aerosol provision system and to provide charge to the battery from the aerosol provision system during the predetermined period of time.

According to a fifth aspect of certain embodiments there is provided an aerosol provision device, for use in an aerosol provision system for generating an aerosol comprising the aerosol provision device and a consumable comprising aerosol-generating material for aerosolising, wherein the aerosol provision device comprises:
a battery for providing electrical power to an aerosol generator from the aerosol provision system; and
at least one sensor for generating sensor data over a predetermined period of time; and
control circuitry, wherein the control circuitry is configured to:
   generate charge level data relating to a charge level in the battery over the predetermined period of time;
   receive the sensor data from the at least one sensor over the predetermined period of time;
   process the sensor data and the charge level data to determine whether a notification should be generated; and
   generate a notification signal in response to determining that the notification should be generated.

According to a sixth aspect of certain embodiments there is provided a method of monitoring the charge level in a battery from an aerosol provision system, wherein the method comprises:
generating, at control circuitry from the aerosol provision system, charge level data relating to a charge level in a battery from the aerosol provision system over a predetermined period of time;
generating sensor data, from at least one sensor of the aerosol provision system, over the predetermined period of time;
receiving, at the control circuitry, the sensor data over the predetermined period of time from the at least one sensor;
processing the sensor data and the charge level data to determine whether a notification should be generated; and
generating a notification signal in response to determining that the notification should be generated.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7 schematically represents an embodiment of aerosol provision system, and a potential communication system for use with such an aerosol provision system, in accordance with certain embodiments of the disclosure.

FIG. 8A schematically represents an embodiment of communication system for use with an aerosol provision system such as that shown in any of FIGS. 1-6B, and where the communication system comprises an electrical device in the form of a docking station, in accordance with certain embodiments of the disclosure.

FIG. 8B schematically represents an embodiment of communication system for use with an aerosol provision system such as that shown in any of FIGS. 1-6B, and where the communication system comprises an electrical device in the form of a charging case, in accordance with certain embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolisable material of the aerosol provision system (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolisable material is not a requirement.

In some embodiments, the aerosol provision system is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporiser therein, and there may be provided an aerosolisable material transport element for receiving the aerosolisable material that is to be vaporised. The aerosol provision system may also be provided with a reservoir for containing aerosolisable material, and in some embodiments a further reservoir for containing flavouring material for flavouring a generated vapour from the aerosol provision system.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) may often comprise a modular assembly including both a reusable part (body- or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

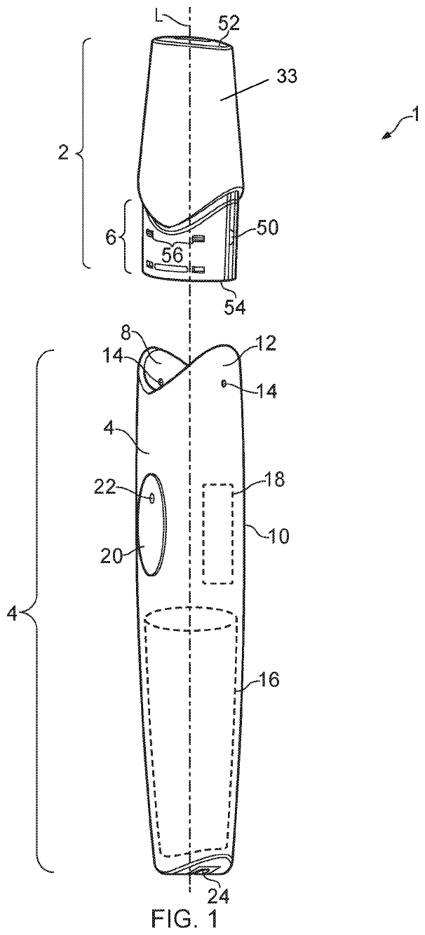

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece 33, a mouthpiece end 52 and an interface end 54 and is coupled to the aerosol provision device by inserting an interface end portion 6 at the interface end of the cartridge into a corresponding receptacle 8/receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

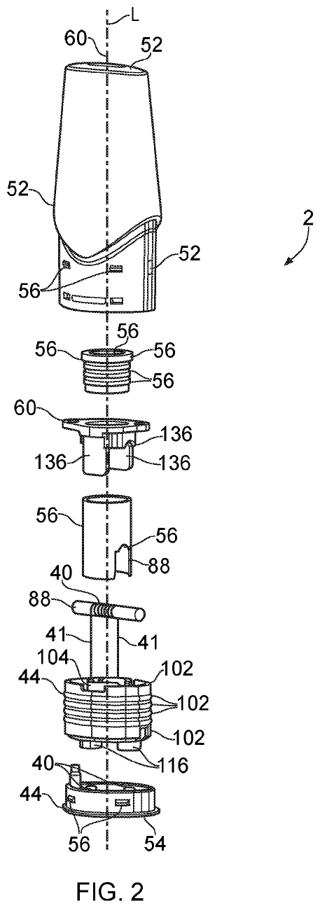

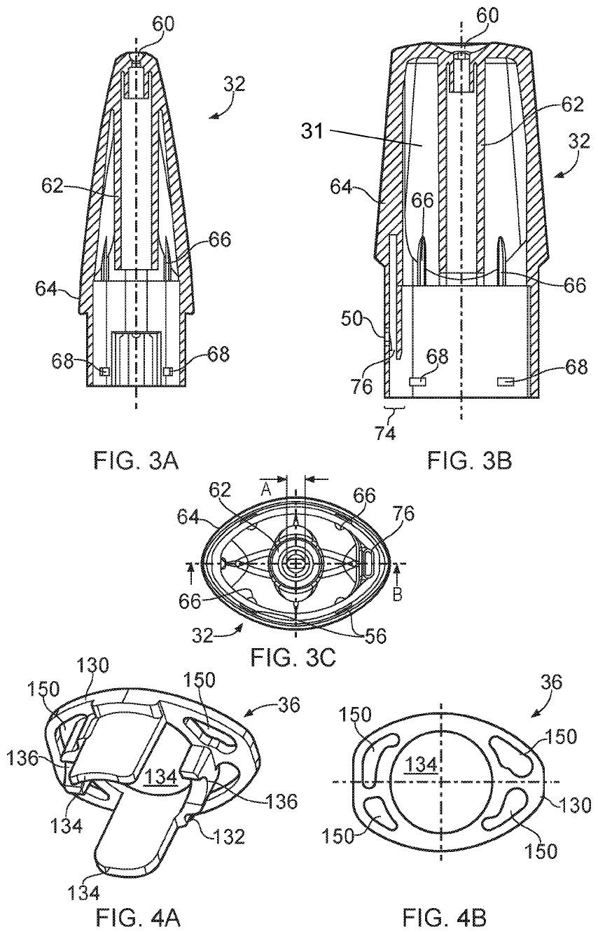

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

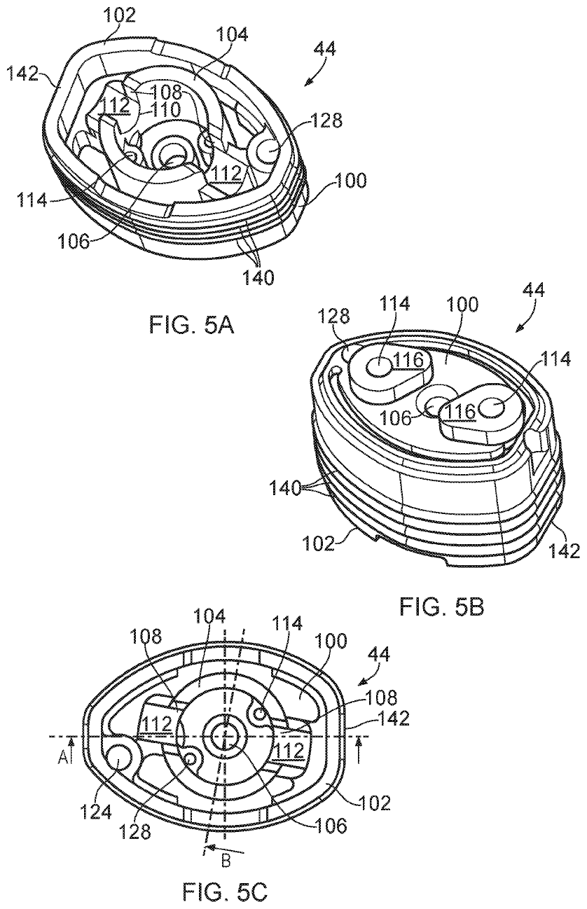

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

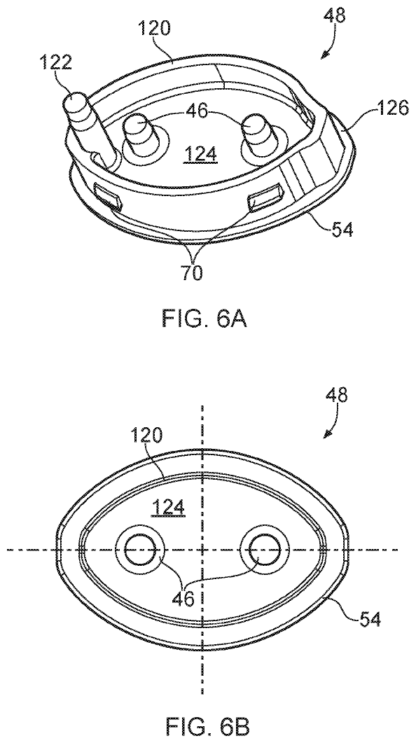

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60, from the mouthpiece 33, which is in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to an aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60, which is located at an end of the mouthpiece 33. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

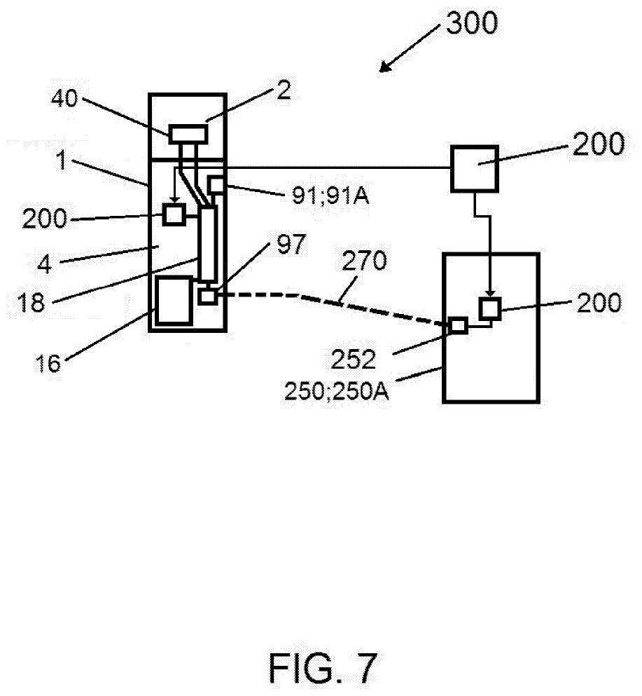

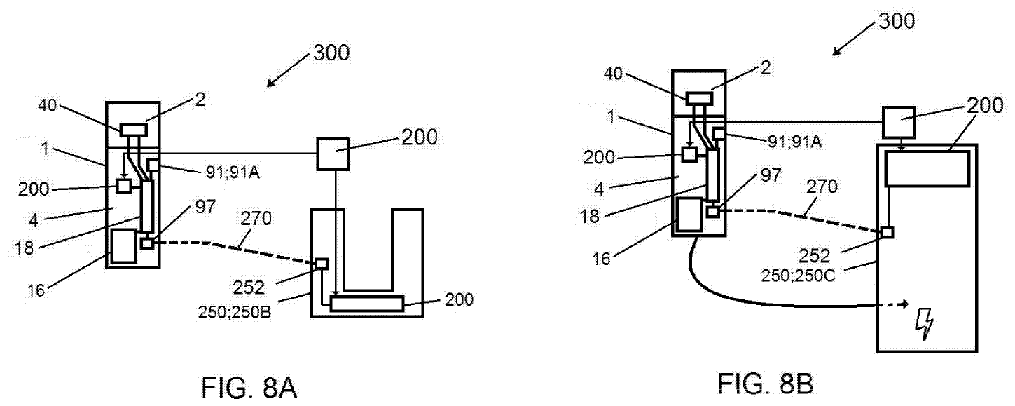

Turning now to FIGS. 7-8B, the present disclosure also provides for other applications and embodiments of aerosol provision system 1 which may complement those embodiments of aerosol provision system illustrated and described above with reference to FIGS. 1-6B.

Thus with reference to FIG. 7 initially, the present disclosure also provides for an aerosol provision system 1 for generating an aerosol, wherein the aerosol provision system comprises an aerosol generator 40 for generating the aerosol, and a battery (power source) 16 for providing electrical power to the aerosol generator 40. The aerosol provision system may be further provided with at least one sensor 91 for generating sensor data over a predetermined period of time, and be provided with control circuitry 18. The control circuitry 18 may be configured to generate charge level data relating to a charge level in the battery over 16 the predetermined period of time; receive the sensor data from the at least one sensor 91 over the predetermined period of time; and process the sensor data and the charge level data to determine whether a notification should be generated. In this way, and in response to determining that the notification should be generated, the control circuitry 18 may be then configured to generate a notification signal.

At a general level therefore, such embodiments may be configured to monitor the charge level of the battery over the predetermined period of time, and then use the sensor data from the sensor 91 relating to this predetermined period of time to determine if the battery 16 is/has been charged in an inefficient manner during this period of time. In this way, and if such an inefficient charging regime is determined as having occurred by the control circuitry 18, the control circuitry 18 may be then configured to generate the notification signal for issuing the notification to a user of the aerosol provision system 1, as will be described. Thus at a general level therefore, such embodiments may be effectively used to assist the user in more efficiently charging the battery 16 of the aerosol provision system 1 moving forward, such to improve the battery life of the battery in the longer term.

In terms of what such a notification may comprise, it may be appreciated that this may comprise a number of different things, depending on how it is determined by the control circuitry 18 as to how the user has been using/charging the battery inefficiently. Though in accordance with some embodiments, the notification may comprise a suggestion to recharge the battery in a predetermined different way, such as to recharge the battery in a different location, or more specifically a suggestion to recharge the battery in a warmer (or cooler) location.

In respect of the above embodiments for instance, the predetermined period of time may comprise a period of time in which the battery is being charged. Equally, and in accordance with some embodiments, the start of the predetermined period of time may comprise a time when the battery from the aerosol provision system is placed on charge. In this way, and in accordance with some additional/alternative embodiments, the end of the predetermined period of time may comprise a time when the battery from the aerosol provision system is no longer placed on charge.

The predetermined period of time, more generally, could also correspond to a period of time in which the battery from the aerosol provision system is placed on charge (recharging), such that the start and/or end of the predetermined period of time need not necessarily cover the complete period of time during which the aerosol provision system is placed on charge. However, by selecting the entire charging duration for the battery, for a given single recharging operation, as the predetermined period of time, this may allow for a more accurate assessment by the control circuitry 18 as to how the battery 16 has been charged as part of that charging operation.

Appreciating the foregoing therefore, in the event that the notification comprises a suggestion to recharge the battery in a warmer (or cooler) location, and/or a suggestion to recharge the battery in a location having a different temperature, this may be in response to the control circuitry 18 determining, for example, from processing the sensor data and the charge level data that the sensor data is indicative of the aerosol provision system having been charged in a location which is determined as being too cold (or too hot) during the predetermined period of time (e.g. a period of time whilst the battery is placed on charge, i.e. recharging).

In the above example, and thus appreciably in accordance some embodiments, it may be appreciated that the at least one sensor 91 may comprise a temperature sensor 91A, such that the sensor data comprises temperature data. In this way for instance, and in accordance with some embodiments thereof, the control circuitry 18 may be configured to monitor the temperature of air surrounding the aerosol provision system 1, such that the temperature data may be configured to relate to the temperature of the air surrounding the aerosol provision system 1 over the predetermined period of time.

Thus with respect to the above embodiments, a first potential application of the control circuitry 18 may be to determine if the aerosol provision system 1 has been charged in a location which is either too hot (e.g. in a location where the aerosol provision system has been left on charge in the sun, or too close to a heater inside a room) or too cold (e.g. on a cold window sill in winter, or left on charge in a cold outdoor location), and which can then provide a notification to the user to avoid such locations being used moving forward, as part of future charging operations for the battery 16. In this way, the provided notification(s) may serve to help preserve the battery from the aerosol provision system 1 in the longer term, through it not being charged in such inappropriate locations moving forward.

Temperature considerations aside, a second potential application may be where the control circuitry 18 is configured to determine if the battery 16 of the aerosol provision system 1 is being charged for too long, such as being left on charge for too long, and/or is being charged too sporadically for short periods of time at a time. In other words, in such applications the control circuitry 18 may be configured to process the sensor data and the charge level data to determine whether the battery 16 has been charged too many times in a predetermined time window, and/or in embodiments where the predetermined period of time corresponds to the period of time in which the battery of the aerosol provision system was placed on charge as part of a single charging operation of the battery, the control circuitry may be configured to determine if the predetermined period of time is less than or is greater than a predetermined duration.

For instance, and in accordance with the above embodiments, where the control circuitry 18 is configured to process the sensor data and the charge level data to determine whether the battery has been charged too many times in a predetermined time window (e.g. more than 3 number times in 5 minutes), this may be indicative of the battery 18 being subjected to too many charging cycles in a given small period of time, which may thus be causing damage to the health of the battery 16 in the longer term. Thus in accordance with such embodiments, and potentially other embodiments, in response to the control circuitry determining that the battery has been charged too many times in a predetermined time window (using the sensor data and the charge level data), the control circuitry 18 may generate the notification signal. Such a notification signal, for instance, may then comprise a notification comprising a suggestion to not interrupt the charging of the battery until it is fully charged or sufficiently charged, and/or a suggestion to not place the battery on charge so frequently. In this way, the control circuitry 18 may therefore act to better prevent damage to the battery in the long term through the battery being otherwise charged inefficiently.

Similarly, in embodiments such as those where the control circuitry 18 is configured to process the sensor data and the charge level data to determine whether the predetermined period of time is less than or is greater than a predetermined duration, and where the predetermined period of time corresponds to the period of time in which the battery of the aerosol provision system was placed on charge as part of a single charging operation of the battery, the control circuitry may generate the notification signal. Such a notification signal, for instance, may then comprise a notification itself comprising a suggestion to charge the battery for longer, or to not recharge the battery for so long. In this way, the control circuitry 18 may therefore be able to act to better prevent damage to the battery in the longer term through assisting with the battery being charged more efficiently as part of future charging cycles—via the notification guiding the user in this respect.

With respect to some of these latter embodiments at least, which may be configured to monitor how long and/or the frequency in which the battery is placed on charge for, it may be appreciated that in accordance with some embodiments, the at least one sensor 91 from the aerosol provisions system (which could be a sensor that is part of the control circuitry 18, in some embodiments) may comprise a sensor 91 which is configured to sense when the battery is placed on charge and sense when the battery is removed from charge. In this way, the sensor data from the sensor 91 may be used by the control circuitry 18, along with the charge level data, to determine whether the battery has been subjected to inefficient charging regimes in a given time period, and/or as part of a single charging operation, as noted above.

It may be seen therefore that the aerosol provision system 1, such as per the embodiment from FIG. 7 at least, may be configured to generate a notification signal using the control circuitry 18 in the event the control circuitry 18 determines using the sensor data and the charge level data that the battery 16 has been subjected to a predetermined inefficient charging operation. Such a predetermined inefficient charging operation, in accordance with some narrower embodiments as explained above, may for instance comprise the battery being determined as being charged in a predetermined inappropriate location (e.g. a location which is determined as being too hot, or too cold), and/or may comprise the being determined as being charged too much, or too many times, in a given period of time (e.g. too quickly, or too frequently in given period of time).

Whatever the cause of the notification signal being generated however, it may be appreciated that the aerosol provision system 1 may in accordance with some embodiments comprise an output device 200 for receiving the notification signal, and for outputting the notification. In this way, the output device 200 may be configured to receive the notification signal from the control circuitry 18, and output the notification in response to receiving the notification signal. As to what any such output device 200 might be, it may be appreciated that this output device 200 could comprise a number of different things, such as a display (where the notification comprises a visual notification); a speaker (where the notification comprises an audio notification); and/or haptic device (where the notification comprises a haptic notification).

As to the location of any such output device(s) 200, in accordance with some embodiments, such as that shown in the embodiment of FIG. 7, the output device 200 may be located on or in the aerosol provision system 1, such as in either a consumable 2 or aerosol provision device 4 therefrom (where such a consumable 2/aerosol provision device 4 arrangement is employed). Appreciably however, in accordance with some embodiments, the output device 200 may be located in an electrical device 250, as part of a wider communication system 300 comprising the aerosol provision system 1 and the electrical device 250, wherein the electrical device 250 is operable to wirelessly communicate with the aerosol provision system 1, e.g. via a wireless connection protocol 270.

As to what such an electrical device 250 might be, it is envisaged that this may comprise any form of electrical device 250 which might operably communicate with the aerosol provision system 1, such as (and certainly not limited to) any of a portable device 250A, such as a tablet computer, smartphone, portable computer, which might be carried by a user of the aerosol provision system 1.

Equally, in accordance with some embodiments, the electrical device 250 may comprise a docking station 250B which is configured to engage with the aerosol provision system, as shown in the embodiment of FIG. 8A.

The electrical device 250 appreciably could also comprise a charging case 250C for the aerosol provision system (as shown in the embodiment of FIG. 8B), wherein the charging case 250C is configured to support the aerosol provision system 1 and to provide charge to the battery 16 for recharging the battery 16 whilst the aerosol provision system 1 is supported by (or inside) the charging case.

As required, it will be appreciated that the electrical device 250 may be operable to communicate with the aerosol provision system 1, such as wirelessly via the wireless connection protocol 270. In this case therefore, appreciably the electrical device 250 may then also comprise a wireless transmitter/receiver/transceiver 252, as appropriate, to facilitate any such wireless communication with the aerosol provision system 1 (which equally may then also comprise a wireless transmitter/receiver/transceiver 97 in communication with the control circuitry 18).

Mindful of the above disclosures therefore, it may be seen that also provided herein may effectively be a corresponding method of monitoring the charge level in a battery from an aerosol provision system, wherein the method comprises: generating, at the control circuitry 18 from the aerosol provision system 1, charge level data relating to a charge level in the battery 16 from the aerosol provision system 1 over a predetermined period of time;

generating sensor data, from at least one sensor 91; 91A of the aerosol provision system 1, over the predetermined period of time; receiving, at the control circuitry 18, the sensor data over the predetermined period of time from the at least one sensor 91; processing the sensor data and the charge level data to determine whether a notification should be generated; and generating a notification signal in response to determining that the notification should be generated.

Any such methods may then appreciably comprise some of the above potential features or steps as outlined above, such as in some embodiments be configured such that the method further comprises receiving the notification signal at the output device 200 from the aerosol provision system 1 (or at an output device from a wider communication system 300), and such that the method may then output the notification (such as any of a visual, audio, and/or haptic notification), from the output device 200 in response to the output device receiving the notification signal.

Appreciating the foregoing therefore, there has accordingly been described an aerosol provision system for generating an aerosol, wherein the aerosol provision system comprises:
an aerosol generator for generating the aerosol;
a battery for providing electrical power to the aerosol generator;
at least one sensor for generating sensor data over a predetermined period of time; and
control circuitry, wherein the control circuitry is configured to:
   generate charge level data relating to a charge level in the battery over the predetermined period of time;
   receive the sensor data from the at least one sensor over the predetermined period of time; and
   process the sensor data and the charge level data to determine whether a notification should be generated; and
   generate a notification signal in response to determining that the notification should be generated.

There has also been described a communication system comprising the aerosol provision system as described above, and an electrical device which is operable to wirelessly communicate with the aerosol provision system, wherein the electrical device further comprises an output device which is configured to:
receive the notification signal from the control circuitry; and
output the notification in response to receiving the notification signal.

There has also been described a charging system comprising any aerosol provision system as described above, or comprising any communication system as described above, wherein the charging system further comprises a charging case configured to support the aerosol provision system and to provide charge to the battery from the aerosol provision system during the predetermined period of time.

There has also been described a charging system comprising any aerosol provision system as described above, or comprising any communication system as described above, wherein the charging system further comprises a docking station configured to support the aerosol provision system and to provide charge to the battery from the aerosol provision system during the predetermined period of time.

There has also been described an aerosol provision device, for use in an aerosol provision system for generating an aerosol comprising the aerosol provision device and a consumable comprising aerosol-generating material for aerosolising, wherein the aerosol provision device comprises:
a battery for providing electrical power to an aerosol generator from the aerosol provision system; and
at least one sensor for generating sensor data over a predetermined period of time; and
control circuitry, wherein the control circuitry is configured to:
   generate charge level data relating to a charge level in the battery over the predetermined period of time;
   receive the sensor data from the at least one sensor over the predetermined period of time;
   process the sensor data and the charge level data to determine whether a notification should be generated; and
   generate a notification signal in response to determining that the notification should be generated.

There has also been described a method of monitoring the charge level in a battery from an aerosol provision system, wherein the method comprises:
generating, at control circuitry from the aerosol provision system, charge level data relating to a charge level in a battery from the aerosol provision system over a predetermined period of time;
generating sensor data, from at least one sensor of the aerosol provision system, over the predetermined period of time;
receiving, at the control circuitry, the sensor data over the predetermined period of time from the at least one sensor;
processing the sensor data and the charge level data to determine whether a notification should be generated; and
generating a notification signal in response to determining that the notification should be generated.

There has also been described an aerosol provision system 1 comprising a battery 16 for providing electrical power to an aerosol generator 40. The system 1 also comprises at least one sensor for generating sensor data over a predetermined period of time, and control circuitry 18 which is configured to process the sensor data and charge level data relating to a charge level in the battery 16 to determine whether a notification should be generated. In response to determining that the notification should be generated, the control circuitry 18 may then generate a notification signal, which could be a notification signal comprising a suggestion, for being output as part of a notification from an output device 200, to recharge the battery 16 in a predetermined different way to improve the performance of the battery 16 in the longer term.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

Purely for completeness, in terms of how any provided sensor 91 or output device 200 may be powered (if they are present at all), it will be appreciated that each sensor 91 or output device 200 may be powered using either the power supply/battery 16 (as shown in the embodiment of FIG. 7), or each powered with its own power source (not shown in the Figures).

Equally, and with regard to the positioning of any such sensor(s) 91 or output device 200, as alluded to above, it will be appreciated that their locations may be provided anywhere in the aerosol provision system 1 (or wider communication system 300, where such a latter system is employed) as may be required to allow them to provide their required functionality. This may even include a location where the sensor 91 or output device 200 is not actually located on the aerosol provision device 4 (e.g. in a separate electrical device 250 which is attachable to the user, such as a strap or some other patch or device which may be secured (releasably if needs be, e.g. via an adhesive patch), to the user.

Equally, and where the aerosol provision system 1 comprises the consumable 2 and the aerosol provision device 4, any provided sensor 91 or output device 200 may be located in either the consumable 2 or the aerosol provision device 4, as needed so as to allow the required functionality of the sensor 91 or output device 200.

For the sake of completeness as well, in respect of any sensor 91 or output device 200 in the aerosol provision device 4 or aerosol provision system 1, it will be appreciated that any power or signals sent thereto may be provided using either a wired or wireless connection between the control circuitry 18 and the sensor 91/output device 200. In the particular embodiments shown in FIG. 7, for instance, a wired connection is provided between each of the sensor 91/output device 200 and the control circuitry 18, and which extends in the case of the sensor 91/output device 200 being located in the consumable 2 across the interface end 54, via the contact electrodes 46 located on each of the aerosol provision device 4 and the consumable 2.

1. An aerosol provision system for generating an aerosol, wherein the aerosol provision system comprises:
an aerosol generator for generating the aerosol;
a battery for providing electrical power to the aerosol generator;
at least one sensor for generating sensor data over a predetermined period of time; and
control circuitry, wherein the control circuitry is configured to:
generate charge level data relating to a charge level in the battery over the predetermined period of time;
receive the sensor data from the at least one sensor over the predetermined period of time;
process the sensor data and the charge level data to determine whether a notification should be generated; and
generate a notification signal in response to determining that the notification should be generated.

2. An aerosol provision system according to claim 1, wherein the notification comprises a suggestion relating to how the battery should be recharged.

3. An aerosol provision system according to claim 1, wherein the notification comprises a suggestion to recharge the battery in a different location.

4. An aerosol provision system according to claim 1, wherein the notification comprises a suggestion to recharge the battery in a warmer location.

5. An aerosol provision system according to claim 1, wherein the notification comprises a suggestion to recharge the battery in a cooler location.

6. An aerosol provision system according to claim 1, wherein the notification comprises a suggestion to not recharge the battery for so long.

7. An aerosol provision system according to claim 1, wherein the notification comprises a suggestion to not interrupt the charging of the battery until it is fully charged.

8. An aerosol provision system according to claim 1, wherein the at least one sensor comprises a temperature sensor, and the sensor data comprises temperature data.

9. An aerosol provision system according to claim 8, wherein the control circuitry is configured to monitor the temperature of air surrounding the aerosol provision system, and the temperature data is configured to relate to the temperature of the air surrounding the aerosol provision system over the predetermined period of time.

10. An aerosol provision system according to claim 1, wherein the aerosol provision system further comprises a consumable for storing aerosol-generating material, and an aerosol provision device which is configured to receive the consumable for generating the aerosol from the aerosol-generating material;
wherein the aerosol provision device comprises the battery and the control circuitry.

11. (canceled)

12. An aerosol provision system according to claim 1, wherein the predetermined period of time is a predetermined period of time occurring whilst the battery is being recharged.

13. An aerosol provision system according to claim 1, wherein the predetermined period of time covers a duration of a recharging operation of the battery.

14-16. (canceled)

17. An aerosol provision system according to claim 1, wherein the aerosol provision system further comprises an output device for receiving the notification signal, and for outputting the notification, wherein the output device is configured to:
receive the notification signal from the control circuitry; and
output the notification in response to receiving the notification signal.

18. A communication system comprising the aerosol provision system according to claim 1, and an electrical device which is operable to wirelessly communicate with the aerosol provision system, wherein the electrical device further comprises an output device which is configured to:
receive the notification signal from the control circuitry; and
output the notification in response to receiving the notification signal.

19. (canceled)

20. A communication system according to claim 18, wherein the electrical device comprises a charging case configured to support the aerosol provision system and to provide charge to the battery.

21-26. (canceled)

27. A method of monitoring the charge level in a battery from an aerosol provision system, wherein the method comprises:
generating, at control circuitry from the aerosol provision system, charge level data relating to a charge level in a battery from the aerosol provision system over a predetermined period of time;
generating sensor data, from at least one sensor of the aerosol provision system, over the predetermined period of time;
receiving, at the control circuitry, the sensor data over the predetermined period of time from the at least one sensor;
processing the sensor data and the charge level data to determine whether a notification should be generated; and
generating a notification signal in response to determining that the notification should be generated.

28. A method according to claim 27, wherein the method further comprises:
receiving the notification signal at an output device from the aerosol provision system; and
outputting the notification from the output device in response to the output device receiving the notification signal.

29. A method according to claim 27, wherein the method further comprises:
charging the battery of the aerosol provision system during the predetermined period of time.

30. A method according to claim 29, wherein the method further comprises:
charging the battery of the aerosol provision system during the predetermined period of time using a docking station on which the aerosol provision system is supported.

31. A method according to claim 29, wherein the method further comprises:
charging the battery of the aerosol provision system during the predetermined period of time using a charging case in which the aerosol provision system is supported.
